(19) United States
(12) Patent Application Publication
(10) Pub. No.: US 2023/0163433 A1
(43) Pub. Date: May 25, 2023

(54) SECONDARY BATTERY, ELECTRONIC EQUIPMENT, AND ELECTRIC TOOL

(71) Applicant: MURATA MANUFACTURING CO., LTD., Kyoto (JP)

(72) Inventor: Akira OTANI, Tokyo (JP)

(21) Appl. No.: 18/095,296

(22) Filed: Jan. 10, 2023

Related U.S. Application Data
(63) Continuation of application No. PCT/JP2021/031913, filed on Aug. 31, 2021.

(30) Foreign Application Priority Data
Sep. 8, 2020 (JP) 2020-150288

(51) Int. Cl. H01M 50/538; H01M 50/107; H01M 4/70; H01M 50/533

(52) U.S. Cl. CPC H01M 50/538; H01M 50/107; H01M 4/70; H01M 50/533

(57) ABSTRACT

A battery is provided that suppresses the occurrence of an internal short circuit due to a turned-up portion generated in a positive electrode. A secondary battery includes an electrode wound body, a positive electrode current collector plate, and an outer package can. The electrode wound body includes a positive electrode having a band shape and a negative electrode having a band shape, the positive electrode and the negative electrode being in a stacked arrangement with a separator interposed therebetween, and being wound. The outer package can contains the electrode wound body and the positive electrode current collector plate. The positive electrode includes a positive electrode active material covered part in which a positive electrode foil is covered with a positive electrode active material layer, and a positive electrode active material uncovered part. The secondary battery includes a flat surface formed by the positive electrode active material uncovered part that protrudes from one end of the electrode wound body being bent toward a central axis of the electrode wound body and portions of the positive electrode active material uncovered part overlapping each other. The flat surface is joined to the positive electrode current collector plate. The positive electrode active material uncovered part has a cutout at one end on an outer periphery side of the electrode wound body.

### CROSS REFERENCE TO RELATED APPLICATIONS

The present application is a continuation of PCT patent application no. PCT/JP2021/031913, filed on Aug. 31, 2021, which claims priority to Japanese patent application no. JP2020-150288, filed on Sep. 8, 2020, the entire contents of which are incorporated herein by reference.

### BACKGROUND

The present application relates to a secondary battery, electronic equipment, and an electronic tool.

Development of lithium ion batteries has expanded to applications that require high output power, including electric tools and electric automobiles. One of methods to achieve high output power is a high-rate discharge in which a relatively large current is fed from a battery.

For example, a structure and a manufacturing method of a battery is provided that makes it possible to increase current collection efficiency and reduce a temperature rise during charging and discharging, as compared with existing techniques. Such a battery is obtained by providing an electrode wound body in which a positive electrode and a negative electrode are stacked on each other with a separator interposed therebetween and are wound, bending a part of the positive electrode not covered with an active material toward a center hole of the electrode wound body, and welding a current collector plate. See, for example, Japanese Unexamined Patent Application Publication No. 2000-294222.

### SUMMARY

The present application relates to a secondary battery, electronic equipment, and an electronic tool.

Employing a technique as described in the Background section can sometimes generate an outwardly turned-up state of a winding end part of a positive electrode in the course of a process after forming an electrode plate group by winding electrodes in a spiral shape, or in the course of a conveyance process. When the electrode plate group is placed into a molding jig and pressed with a pressing tool through an opening at an end of the molding jig, the turned-up portion can break through a separator located in an outermost wind of an electrode wound body to thereby come into contact with a negative electrode. This can result in the occurrence of an internal short circuit.

The present application relates to providing a battery that suppresses the occurrence of an internal short circuit due to a turned-up portion generated in the positive electrode according to an embodiment.

In order to solve the above-described problem, the present application, in an embodiment, provides a secondary battery including an electrode wound body, a positive electrode current collector plate, and an outer package can. The electrode wound body includes a positive electrode having a band shape and a negative electrode having a band shape. The positive electrode and the negative electrode are stacked on each other with a separator interposed therebetween, and are wound. The outer package can contains the electrode wound body and the positive electrode current collector plate. The positive electrode includes a positive electrode active material covered part in which a positive electrode foil is covered with a positive electrode active material layer, and a positive electrode active material uncovered part. The secondary battery includes a flat surface formed by the positive electrode active material uncovered part that protrudes from one end of the electrode wound body being bent toward a central axis of the electrode wound body and portions of the positive electrode active material uncovered part overlapping each other. The flat surface is joined to the positive electrode current collector plate. The positive electrode active material uncovered part has a cutout at one end on an outer periphery side of the electrode wound body.

### BRIEF DESCRIPTION OF THE FIGURES

FIG. 1 is a sectional view of a battery according to an embodiment.

FIG. 2 is a diagram illustrating an example of an arrangement relationship between a positive electrode, a negative electrode, and a separator in an electrode wound body.

FIG. 3 includes views A and B, where view A is a plan view of a positive electrode current collector plate, and where view B is a plan view of a negative electrode current collector plate.

FIG. 4 includes views A to F which are diagrams describing an assembly process of the battery according to an embodiment.

FIG. 5 is a diagram for describing positions of laser welding marks.

FIG. 6 is a diagram for describing a cutout according to one embodiment.

FIG. 7 includes views A to C which are diagrams for describing Example 1, Comparative example 1, and Comparative example 2.

FIG. 8 includes views A to C which are diagrams for describing Comparative example 1 and Comparative example 2.

FIG. 9 includes views A-1 to D-1 and views A-2 to D-2 which are diagrams for describing Examples 2 to 5.

FIG. 10 is a diagram for describing a modification.

FIG. 11 is a coupling diagram for use to describe a battery pack as an application example of the present technology.

FIG. 12 is a coupling diagram for use to describe an electric tool as an application example of the present technology.

FIG. 13 is a coupling diagram for use to describe an electric vehicle as an application example of the present technology.

### DETAILED DESCRIPTION

One or more embodiments of the present technology are described below in further detail, without limitation, including with reference to the drawings and examples.

In an embodiment, a lithium ion battery having a cylindrical shape will be described as an example of a secondary battery.

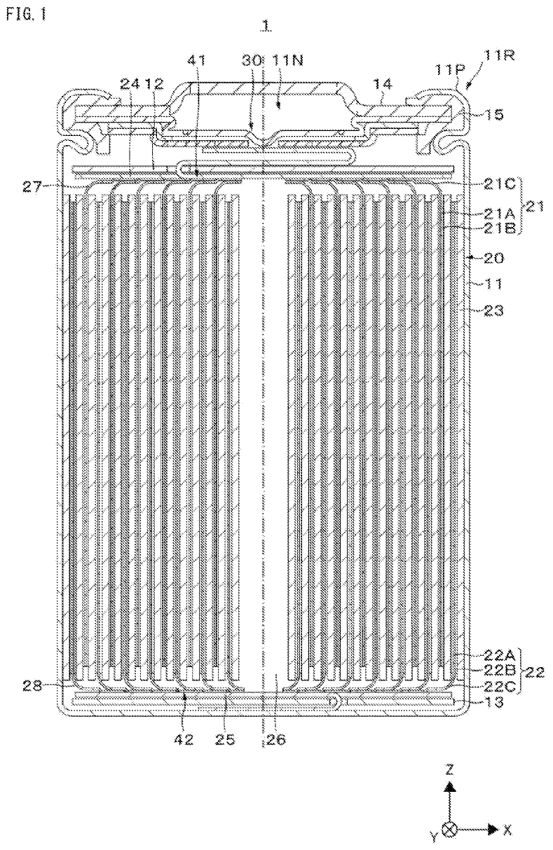

Description is given first of an overall configuration of the lithium ion battery. FIG. 1 is a schematic sectional view of a lithium ion battery 1. The lithium ion battery 1 is, for example, a cylindrical lithium ion battery 1 in which an electrode wound body 20 is contained inside a battery can 11, as illustrated in FIG. 1.

Specifically, the lithium ion battery 1 includes, for example, a pair of insulating plates 12 and 13 and the electrode wound body 20 inside the battery can 11 having a cylindrical shape. Note that the lithium ion battery 1 may further include, for example, one or more of devices and members including, without limitation, a thermosensitive resistive device or a PTC device and a reinforcing member, inside the battery can 11.

The battery can 11 is a member that contains the electrode wound body 20, for example. The battery can 11 is, for example, a cylindrical container with one end face open and another end face closed. That is, the battery can 11 has one open end face (an open end face 11N). The battery can 11 includes, for example, one or more of metal materials including, without limitation, iron, aluminum, and alloys thereof. Further, for example, the battery can 11 may have a surface plated with one or more of metal materials including, without limitation, nickel.

The insulating plates 12 and 13 are disk-shaped plates each having a surface that is generally perpendicular to a central axis of the electrode wound body 20. Further, the insulating plate 12 and 13 are disposed with the wound electrode body 20 interposed therebetween, for example.

A battery cover 14 and a safety valve mechanism 30 are crimped to the open end face 11N of the battery can 11 via a gasket 15 to thereby provide a crimp structure 11R. The battery can 11 is thus sealed in a state where the electrode wound body 20 and other components are contained inside the battery can 11.

The battery cover 14 is a member that closes the open end face 11N of the battery can 11 in the state where the electrode wound body 20 and the other components are contained inside the battery can 11, for example. The battery cover 14 includes, for example, a material similar to the material included in the battery can 11. A middle region of the battery cover 14 protrudes in a +Z direction, for example. A region other than the middle region, that is, a peripheral region, of the battery cover 14 is thus in contact with the safety valve mechanism 30, for example.

The gasket 15 is a member that is interposed, for example, between the battery can 11 (a bent part 11P) and the battery cover 14 to thereby seal a gap between the bent part 11P and the battery cover 14. Note that the gasket 15 may have a surface coated with a material such as asphalt.

The gasket 15 includes, for example, one or more of insulating materials. Although not particularly limited in kind, the insulating material may be, for example, a polymer material such as polybutylene terephthalate (PBT) or polypropylene (PP). In particular, the insulating material may be polybutylene terephthalate. A reason for this is that the gap between the bent part 11P and the battery cover 14 is sufficiently sealed while the battery can 11 and the battery cover 14 are electrically separated from each other.

The safety valve mechanism 30 releases the sealed state of the battery can 11 on an as-needed basis when, for example, a pressure inside the battery can 11, i.e., an internal pressure of the battery can 11, is increased. Examples of a cause of the increase in the internal pressure of the battery can 11 include a gas generated due to a decomposition reaction of an electrolytic solution during charging and discharging.

In the cylindrical lithium ion battery, a positive electrode 21 having a band shape and a negative electrode 22 having a band shape that are stacked on each other with a separator 23 interposed therebetween and are wound in a spiral shape are contained in the battery can 11 in a state of being impregnated with the electrolytic solution. The positive electrode 21 includes a positive electrode foil 21A with a positive electrode active material layer provided on one of or each of both sides of the positive electrode foil 21A. The positive electrode foil 21A includes a metal foil including, for example, aluminum or an aluminum alloy. The negative electrode 22 includes a negative electrode foil 22A with a negative electrode active material layer provided on one of or each of both sides of the negative electrode foil 22A. The negative electrode foil 22A includes a metal foil including, for example, nickel, a nickel alloy, copper, or a copper alloy. The separator 23 is a porous insulating film. The separator 23 electrically insulates the positive electrode 21 and the negative electrode 22 from each other, and allows movement of substances including, without limitation, ions and the electrolytic solution.

The positive electrode active material layer and the negative electrode active material layer cover most of the positive electrode foil 21A and most of the negative electrode foil 22A, respectively, but do not cover, on purpose, respective parts of the foils located at and near respective one ends in a short-axis direction of the bands. Hereinafter, where appropriate, the parts not covered with the respective active material layers will be referred to as active material uncovered parts 21C and 22C, and parts covered with the respective active material layers will be referred to as active material covered parts 21B and 22B. In the electrode wound body 20 of the cylindrical battery, the positive electrode 21 and the negative electrode 22 are laid over each other and wound with the separator 23 interposed therebetween in such a manner that the active material uncovered part 21C of the positive electrode and the active material uncovered part 22C of the negative electrode face toward opposite directions.

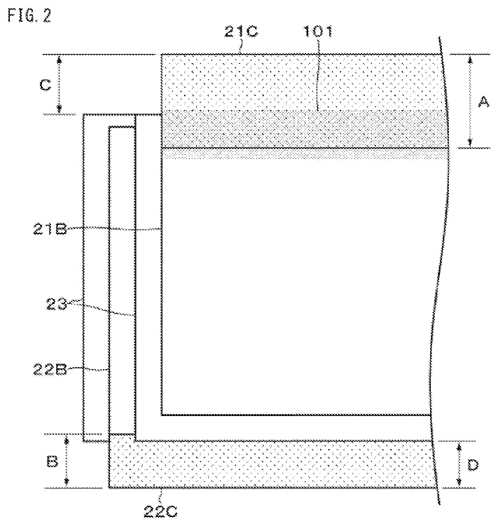

FIG. 2 illustrates an example of a pre-winding structure in which the positive electrode 21, the negative electrode 22, and the separator 23 are stacked on each other. The active material uncovered part 21C of the positive electrode (a shaded portion on the upper side in FIG. 2) has a width A, and the active material uncovered part 22C of the negative electrode (a shaded portion on the lower side in FIG. 2) has a width B. In an embodiment, A may be greater than B. For example, A is 7 (mm), and B is 4 (mm). A portion of the active material uncovered part 21C of the positive electrode protruding from one end in a width direction of the separator 23 has a length C. A portion of the active material uncovered part 22C of the negative electrode protruding from another end in the width direction of the separator 23 has a length D. In an embodiment, C may be greater than D. For example, C is 4.5 (mm), and D is 3 (mm).

The active material uncovered part 21C of the positive electrode includes, for example, aluminum, and the active material uncovered part 22C of the negative electrode includes, for example, copper. Thus, the active material uncovered part 21C of the positive electrode is typically softer, that is, lower in Young's modulus, than the active material uncovered part 22C of the negative electrode. Accordingly, in an embodiment, both A>B and C>D may be satisfied. In such a case, when the active material uncovered part 21C of the positive electrode and the active material uncovered part 22C of the negative electrode are simultaneously bent with equal pressures from both electrode sides, respective heights of the bent portions as measured from respective ends of the separator 23 are almost the same between the positive electrode 21 and the negative electrode 22 in some cases. At this time, the active material uncovered parts 21C and 22C are bent and portions of each of the active material uncovered parts 21C and 22C appropriately overlap each other. This makes it possible to easily join the active material uncovered parts 21C and 22C to current collector plates 24 and 25, respectively, by laser welding. In an embodiment, joining refers to coupling electrically; however, a method of joining is not limited to laser welding.

In the positive electrode 21, a section of a 3-mm width including a boundary between the active material uncovered part 21C and the active material covered part 21B is covered with an insulating layer 101 (a gray region in FIG. 2). In addition, all of a region of the active material uncovered part 21C of the positive electrode that is opposed to the active material covered part 22B of the negative electrode with the separator interposed therebetween is covered with the insulating layer 101. The insulating layer 101 has an effect of preventing an internal short circuit of the battery 1 with reliability when foreign matter enters between the active material covered part 22B of the negative electrode and the active material uncovered part 21C of the positive electrode. In addition, the insulating layer 101 has, when the battery 1 undergoes an impact, an effect of absorbing the impact on the battery 1 and thereby preventing bending of the active material uncovered part 21C of the positive electrode and a short circuit with the negative electrode 22, with reliability.

The electrode wound body 20 has a through hole 26 at a center thereof. The through hole 26 is a hole through which a winding core for assembling the electrode wound body 20 and an electrode rod for welding are to be placed. In the electrode wound body 20, the positive electrode 21 and the negative electrode 22 are laid over each other and wound in such a manner that the active material uncovered part 21C of the positive electrode and the active material uncovered part 22C of the negative electrode face toward opposite directions. Thus, the active material uncovered part 21C of the positive electrode is localized to one end face, i.e., an end face 41, of the electrode wound body, and the active material uncovered part 22C of the negative electrode is localized to another end face, i.e., an end face 42, of the electrode wound body 20. In order to improve contact with the current collector plates 24 and 25 which serve to extract currents, the active material uncovered parts 21C and 22C are bent and the end faces 41 and 42 are thus made into flat surfaces. The direction of bending is from an outer edge part 27 of the end face 41 toward the through hole 26 or from an outer edge part 28 of the end face 42 toward the through hole 26. Thus, portions of the active material uncovered part that are located in adjacent winds in a wound state overlap each other and are bent. As used herein, the “flat surface” includes not only a completely flat surface but also a surface having some asperities or surface roughness to the extent that it is possible to join the active material uncovered parts to the current collector plates.

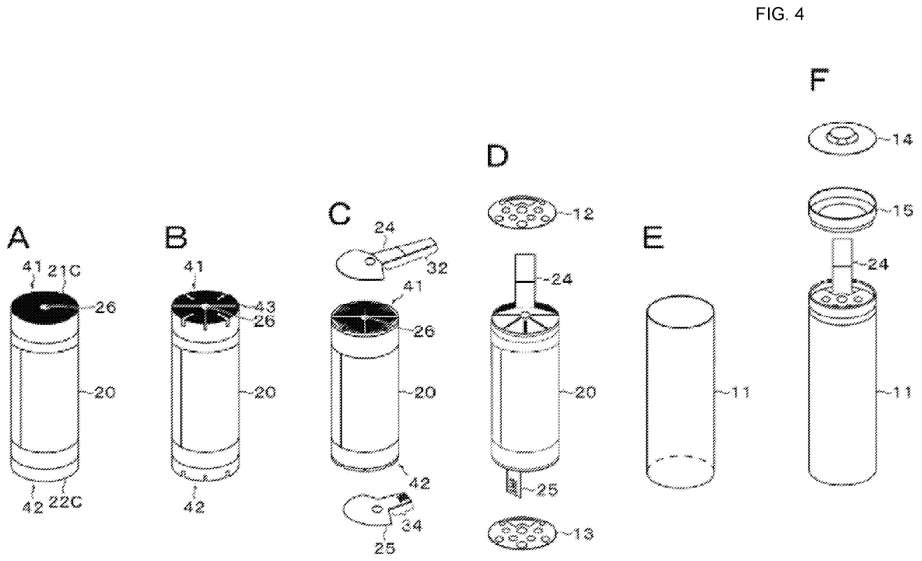

It may seem to be possible to make the end faces 41 and 42 into flat surfaces by bending each of the active material uncovered parts 21C and 22C in such a manner that portions thereof overlap each other; however, without any processing in advance of bending, creases or voids (gaps or spaces) will develop in the end faces 41 and 42 upon bending, thus making it difficult for the end faces 41 and 42 to become flat surfaces. Here, “wrinkles” and “voids” are unevenness in the active material uncovered parts 21C and 22C occurring when they are bent, resulting in non-flatness of the end faces 41 and 42. To prevent the occurrence of the wrinkles and voids, grooves 43 (see, for example FIG. 4B) are formed in advance in radial directions from the through hole 26. The grooves 43 each extend from the outer edge part 27 of the end face 41 to the through hole 26 or from the outer edge part 28 of the end face 42 to the through hole 26. The through hole 26 is positioned at the center of the electrode wound body 20. The through hole 26 is used as a hole through which a welding tool is to be placed in the assembly process of the lithium ion battery 1. Respective portions of the active material uncovered parts 21C and 22C at the beginning of winding of the positive electrode 21 and the negative electrode 22 near the through hole 26 are provided with cutouts. This is to prevent the through hole 26 from being closed by the active material uncovered parts 21C and 22C when they are bent toward the through hole 26. The grooves 43 remain in each of the flat surfaces even after the active material uncovered parts 21C and 22C are bent, and portions of each flat surface having no grooves 43 are thus joined (e.g., welded) to corresponding one of the positive electrode current collector plate 24 and the negative electrode current collector plate 25. Note that the grooves 43, as well as the flat surface, may be joined to portions of the current collector plate 24 or 25. A detailed configuration of the electrode wound body 20, that is, a detailed configuration of each of the positive electrode 21, the negative electrode 22, the separator 23, and the electrolytic solution will be described later.

In a typical lithium ion battery, for example, a lead for current extraction is welded at one location on each of the positive electrode and the negative electrode; however, this is not suitable for a high-rate discharge because a high internal resistance of the battery will result and cause the lithium ion battery to generate heat and become high in temperature during discharging. To cope with this, in the lithium ion battery according to one embodiment, the internal resistance of the battery is kept low by disposing the positive electrode current collector plate 24 at the end face 41 and the negative electrode current collector plate 25 at the end face 42, and welding, at multiple points, the positive electrode current collector plate 24 and the negative electrode current collector plate 25 respectively to the active material uncovered part 21C of the positive electrode located at the end face 41 and the active material uncovered part 22C of the negative electrode located at the end face 42. The configuration in which the end faces 41 and 42 are formed by bending into flat surfaces also contributes to reduction in resistance.

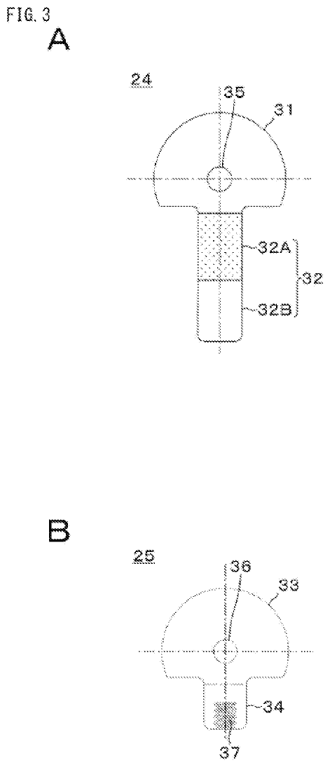

FIGS. 3A and 3B illustrate an example of the current collector plates. FIG. 3A illustrates the positive electrode current collector plate 24. FIG. 3B illustrates the negative electrode current collector plate 25. The positive electrode current collector plate 24 includes, for example, a metal plate including a simple substance or a composite material of aluminum or an aluminum alloy. The negative electrode current collector plate 25 includes, for example, a metal plate including a simple substance or a composite material of nickel, a nickel alloy, copper, or a copper alloy, that is, a cladding material. As illustrated in FIG. 3A, the positive electrode current collector plate 24 has a shape in which a band-like part 32 having a rectangular shape is attached to a plate-like part 31 having a flat fan shape. The plate-like part 31 has a hole 35 at a position near a middle thereof. The position of the hole 35 corresponds to that of the through hole 26.

A shaded region in FIG. 3A represents an insulating part 32A where an insulating tape or an insulating material is attached or applied to the band-like part 32. A region below the shaded region in FIG. 3A represents a coupling part 32B to be coupled to a sealing plate that also serves as an external terminal. Note that in a case of a battery structure without a metallic center pin (not illustrated) in the through hole 26, the insulating part 32A may be omitted because there is a low possibility that the band-like part 32 comes into contact with a part having a negative electrode potential. In such a case, it is possible to increase charge and discharge capacities by increasing a width of each of the positive electrode 21 and the negative electrode 22 by an amount corresponding to a thickness of the insulating part 32A.

The negative electrode current collector plate 25 has a shape that is almost the same as the shape of the positive electrode current collector plate 24, but is different in band-like part. A band-like part 34 of the negative electrode current collector plate 25 in FIG. 3B is shorter than the band-like part 32 of the positive electrode current collector plate, and includes no portion corresponding to the insulating part 32A. The band-like part 34 includes circular projections 37 depicted as multiple circles. Upon resistance welding, current is concentrated on the projections, and the projections thus melt to allow the band-like part 34 to be welded to the bottom of the battery can 11. Like the positive electrode current collector plate 24, the negative electrode current collector plate 25 has a hole 36 at a position near a middle of a plate-like part 33. The position of the hole 36 corresponds to that of the through hole 26. The plate-like part 31 of the positive electrode current collector plate 24 and the plate-like part 33 of the negative electrode current collector plate 25 each have a fan shape, and thus cover respective portions of the end faces 41 and 42. A reason for not covering all of each of the end faces is to allow the electrolytic solution to smoothly permeate the electrode wound body in assembling the battery, or to allow gas generated when the battery comes into an abnormally high-temperature state or an overcharged state to be easily released to the outside of the battery.

The positive electrode active material layer includes at least a positive electrode material (a positive electrode active material) into which lithium is insertable and from which lithium is extractable, and may further include, for example, a positive electrode binder and a positive electrode conductor. The positive electrode material may be a lithium-containing composite oxide or a lithium-containing phosphoric acid compound. The lithium-containing composite oxide has, for example, a layered rock-salt crystal structure or a spinel crystal structure. The lithium-containing phosphoric acid compound has, for example, an olivine crystal structure.

The positive electrode binder includes a synthetic rubber or a polymer compound. Examples of the synthetic rubber include a styrene-butadiene-based rubber, a fluorine-based rubber, and ethylene propylene diene. Examples of the polymer compound include polyvinylidene difluoride (PVdF) and polyimide.

The positive electrode conductor is a carbon material such as graphite, carbon black, acetylene black, or Ketjen black. Note that the positive electrode conductor may be a metal material or a polymer compound.

The positive electrode foil 21A may have a thickness within a range from 5 μm to 20 μm both inclusive. A reason for this is that setting the thickness of the positive electrode foil 21A to 5 μm or more allows manufacturing without breakage of the positive electrode 21 when the positive electrode 21, the negative electrode 22, and the separator 23 are laid over each other and wound. A further reason is that setting the thickness of the positive electrode foil 21A to 20 μm or less makes it possible to prevent a decrease in energy density of the battery 1 and allows the positive electrode 21 and the negative electrode 22 to be opposed to each other over a large area, thus allowing the battery 1 to have high output power.

The negative electrode foil 22A may have a surface roughened for improved adherence to the negative electrode active material layer. The negative electrode active material layer includes at least a negative electrode material (a negative electrode active material) into which lithium is insertable and from which lithium is extractable, and may further include, for example, a negative electrode binder and a negative electrode conductor.

The negative electrode material includes, for example, a carbon material. The carbon material is graphitizable carbon, non-graphitizable carbon, graphite, low-crystalline carbon, or amorphous carbon. The carbon material has a fibrous shape, a spherical shape, a granular shape, or a scale-like shape.

Further, the negative electrode material includes, for example, a metal-based material. Examples of the metal-based material include Li (lithium), Si (silicon), Sn (tin), Al (aluminum), Zr (zinc), and Ti (titanium). A metallic element forms a compound, a mixture, or an alloy with another element, and examples thereof include silicon oxide (SiOₓ (0<x≤2)), silicon carbide (SiC), an alloy of carbon and silicon, and lithium titanium oxide (LTO).

The negative electrode foil 22A may have a thickness within a range from 5 μm to 20 μm both inclusive. A reason for this is that setting the thickness of the negative electrode foil 22A to 5 μm or more allows manufacturing without breakage of the negative electrode 22 when the positive electrode 21, the negative electrode 22, and the separator 23 are laid over each other and wound. A further reason is that setting the thickness of the negative electrode foil 22A to 20 μm or less makes it possible to prevent a decrease in energy density of the battery 1 and allows the positive electrode 21 and the negative electrode 22 to be opposed to each other over a large area, thus allowing the battery 1 to have high output power.

The separator 23 is a porous film including resin, and may be a layered film including two or more kinds of porous films. Examples of the resin include polypropylene and polyethylene. The separator 23 may include a base layer including the porous film, and a resin layer provided on one side or each of both sides of the base layer. A reason for this is that adherence of the separator 23 to each of the positive electrode 21 and the negative electrode 22 improves to suppress distortion of the electrode wound body 20.

The resin layer includes a resin such as PVdF. In a case of forming the resin layer, a solution including an organic solvent and the resin dissolved therein is applied on the base layer, following which the base layer is dried. Note that the base layer may be immersed in the solution and thereafter the base layer may be dried. From the viewpoint of improving heat resistance and battery safety, the resin layer may include inorganic particles or organic particles. Examples of the kind of the inorganic particles include aluminum oxide, aluminum nitride, aluminum hydroxide, magnesium hydroxide, boehmite, talc, silica, and mica. Alternatively, a surface layer including inorganic particles and formed by a method such as a sputtering method or an atomic layer deposition (ALD) method may be used instead of the resin layer.

The separator 23 may have a thickness within a range from 4 μm to 30 μm both inclusive. Setting the thickness of the separator 23 to 4 μm or more makes it possible to prevent an internal short circuit caused by contact between the positive electrode 21 and the negative electrode 22 which are opposed to each other with the separator 23 interposed therebetween. Setting the thickness of the separator 23 to 30 μm or less makes it possible for lithium ions and the electrolytic solution to easily pass through the separator 23, and makes it possible for the positive electrode 21 and the negative electrode 22 to achieve high electrode density when wound.

The electrolytic solution includes a solvent and an electrolyte salt, and may further include other materials such as additives on an as-needed basis. The solvent is a nonaqueous solvent such as an organic solvent, or water. The electrolytic solution including a nonaqueous solvent is called a nonaqueous electrolytic solution. Examples of the nonaqueous solvent include a cyclic carbonic acid ester, a chain carbonic acid ester, a lactone, a chain carboxylic acid ester, and a nitrile (mononitrile).

Although a typical example of the electrolyte salt is a lithium salt, the electrolyte salt may include any salt other than the lithium salt. Examples of the lithium salt include lithium hexafluorophosphate (LiPF₆), lithium tetrafluoroborate (LiBF₄), lithium perchlorate (LiClO₄), lithium methanesulfonate (LiCH₃SO₃), lithium trifluoromethanesulfonate (LiCF₃SO₃), and dilithium hexafluorosilicate (Li₂SF₆). These salts may also be used in mixture with each other. From the viewpoint of improving a battery characteristic, a mixture of LiPF₆ and LiBF₄ may be used, in particular. Although not particularly limited, a content of the electrolyte salt is preferably in a range from 0.3 mol/kg to 3 mol/kg both inclusive with respect to the solvent.

A description will be given of a method of fabricating the lithium ion battery 1 according to the embodiment with reference to FIGS. 4A to 4F. First, the positive electrode active material was applied on the surface of the positive electrode foil 21A having a band shape to form the covered part of the positive electrode 21, and the negative electrode active material was applied on the surface of the negative electrode foil 22A having a band shape to form the covered part of the negative electrode 22. At this time, the active material uncovered part 21C without the positive electrode active material applied thereon and the active material uncovered part 22C without the negative electrode active material applied thereon were provided at one end in a transverse direction of the positive electrode 21 and one end in the transverse direction of the negative electrode 22, respectively. The cutouts were formed in the respective portions of the active material uncovered parts 21C and 22C that correspond to the ends of winding of the electrodes as wound. The positive electrode 21 and the negative electrode 22 were subjected to processes including a drying process. Thereafter, the positive electrode 21 and the negative electrode 22 were laid over each other with the separator 23 interposed therebetween in such a manner that the active material uncovered part 21C of the positive electrode and the active material uncovered part 22C of the negative electrode faced toward opposite directions, and they were wound in a spiral shape to allow the through hole 26 to be present at the center and to allow the formed cutouts to be located on an outer periphery side of the electrode wound body. Thus, the electrode wound body 20 as illustrated in FIG. 4A was fabricated.

Next, as illustrated in FIG. 4B, the grooves 43 were formed in portions of the end faces 41 and 42 by pressing an end of a material such as a thin flat plate (for example, 0.5 mm in thickness) perpendicularly against the end faces 41 and 42. In this way, the grooves 43 were formed to extend radially from the through hole 26. The number and arrangement of the grooves 43 illustrated in FIG. 4B are merely one example. Thereafter, as illustrated in FIG. 4C, the end faces 41 and 42 were made into flat surfaces by applying equal pressures to the end faces 41 and 42 simultaneously from both electrode sides in directions generally perpendicular to the end faces 41 and 42 to thereby bend the active material uncovered part 21C of the positive electrode and the active material uncovered part 22C of the negative electrode. At this time, a load was applied with, for example, a plate surface of a flat plate to cause the active material uncovered part located at each of the end faces 41 and 42 to be bent toward the central axis and cause portions of the active material uncovered part to overlap each other. Thereafter, the plate-like part 31 of the positive electrode current collector plate 24 was laser-welded to the end face 41, and the plate-like part 33 of the negative electrode current collector plate 25 was laser-welded to the end face 42.

Thereafter, as illustrated in FIG. 4D, the band-like parts 32 and 34 of the current collector plates 24 and 25 were bent and the insulating plates 12 and 13 (or insulating tapes) were respectively attached to the positive electrode current collector plate 24 and the negative electrode current collector plate 25. The electrode wound body 20 assembled in the above-described manner was placed into the battery can 11 illustrated in FIG. 4E, and the bottom of the battery can 11 was welded. The electrolytic solution was injected into the battery can 11, following which the battery can 11 was sealed with the gasket 15 and the battery cover 14 as illustrated in FIG. 4F.

### EXAMPLES

In the following, the present technology will be described with reference, without limitation, to Examples in which the lithium ion batteries 1 fabricated in the above-described manner were used to compare the numbers of open circuit voltage defects, the numbers of welding defects, and impedances.

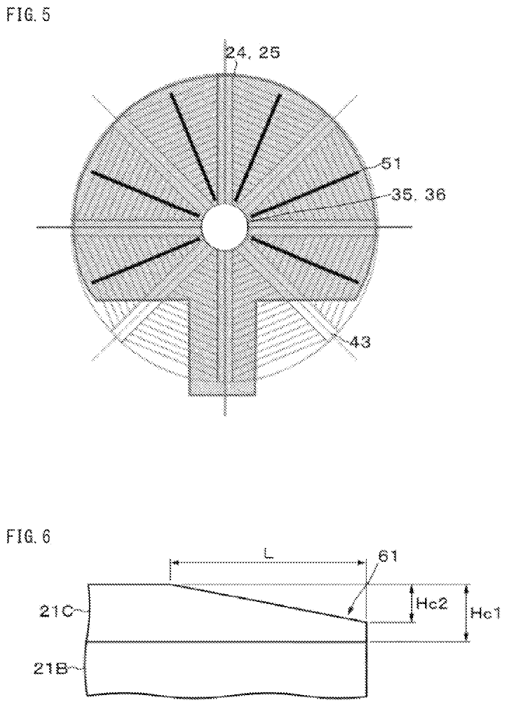

In each of all Examples and Comparative examples described below, the size of the cylindrical battery was set to be 21 mm in diameter and 70 mm in height, the number of the grooves 43 was set to eight, and the grooves 43 were arranged at generally equal angular intervals. Laser welding was performed at positions arranged as illustrated in FIG. 5 to join the positive electrode current collector plate 24 and the active material uncovered part 21C of the positive electrode to each other, and to join the negative electrode current collector plate 25 and the active material uncovered part 22C of the negative electrode to each other. FIG. 5 is a schematic diagram illustrating the end face of the wound body and the grooves as viewed through the current collector plate in order to describe positions of laser welding marks. Thick solid-line portions in FIG. 5 represent laser welding marks 51. The laser welding marks 51 were each provided in a linear shape to extend from a position near the hole 35 or 36 to the outer periphery, and were arranged at generally equal angular intervals, one each between adjacent grooves 43. As illustrated in FIG. 5, six laser welding marks 51 were arranged in a region covered by each of the current collector plate 24 and 25. Each laser welding mark 51 had a length of 6 mm.

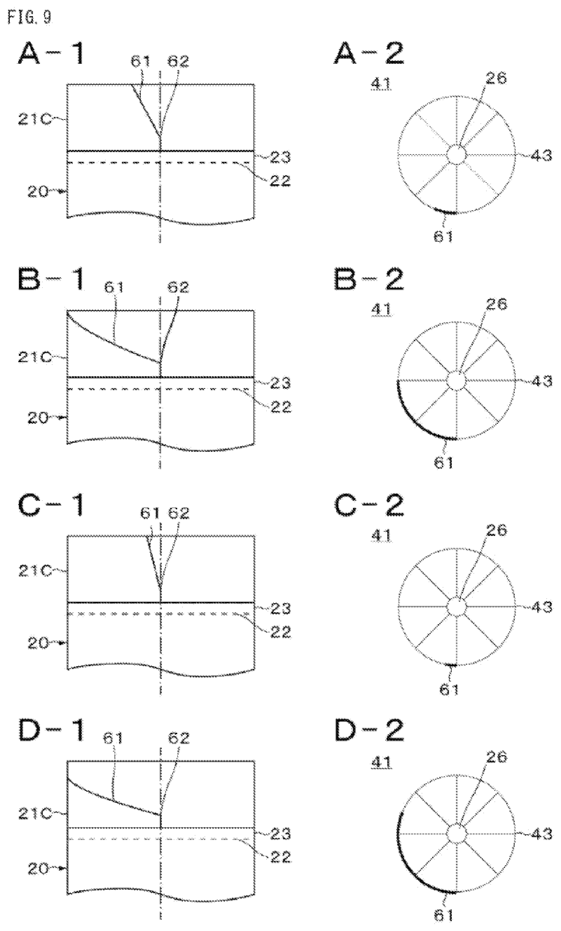

FIG. 6 is a diagram that describes a cutout 61 provided in the active material uncovered part 21C of the positive electrode 21. The positive electrode 21 is in a state of being spread on a plane, and the illustration of the insulating layer 101 is omitted. As illustrated in FIG. 6, the cutout 61 was formed at one end in the transverse direction of the positive electrode 21 on a winding-end side (the right side in FIG. 6) of the electrode wound body 20. The cutout 61 is intended to prevent generation of a turned-up portion in the positive electrode 21 (a turned-up portion in a winding end part 63) in the electrode wound body 20 (see FIG. 4A). If there is a turned-up portion in the positive electrode 21, as will be described later, the turned-up portion of the positive electrode 21 can break through the separator 23 to come into contact with the negative electrode 22 after bending of the active material uncovered part 21C of the positive electrode. To avoid a short circuit due to such contact, a length L of the cutout 61 along a longitudinal direction of the positive electrode 21 may fall within a range from 1/16 winds to ¼ winds both inclusive. Note that the length L of the cutout 61 along the longitudinal direction of the positive electrode 21 being 1/16 winds means that a proportion of the length L to a length of one wind on the peripheral surface of the electrode wound body 20 is 1/16. The length of one wind on the peripheral surface of the electrode wound body 20 is calculable by measuring a diameter of the electrode wound body 20. Any length L described hereinafter has a similar meaning to the above. For example, FIG. 9B-1 is a side view of the electrode wound body with the cutout 61. FIG. 9B-2 is a plan view of the end face of the same electrode wound body as viewed in a central axis direction. The cutout 61 on the outer periphery of the wound body is indicated in a thick solid line. The proportion of the length L of the cutout 61 to a circumferential length of the wound body is ¼. If the cutout 61 extends to the active material covered part 21B of the positive electrode, an internal short circuit of the battery easily occurs due to the active material coming off a cut surface of the cutout 61. It is thus necessary for the cutout 61 to be within the active material uncovered part 21C of the positive electrode. It is necessary that Hc1≥Hc2 where Hc1 is the width of the active material uncovered part 21C, and Hc2 is the width of the cutout 61 in the transverse direction. The grooves 43 were so arranged that an end 62 of the cutout 61 on the winding end side is located on an extension of one of the eight grooves 43 on the end face 41 illustrated in each of FIGS. 9A-2 to 9D-2.

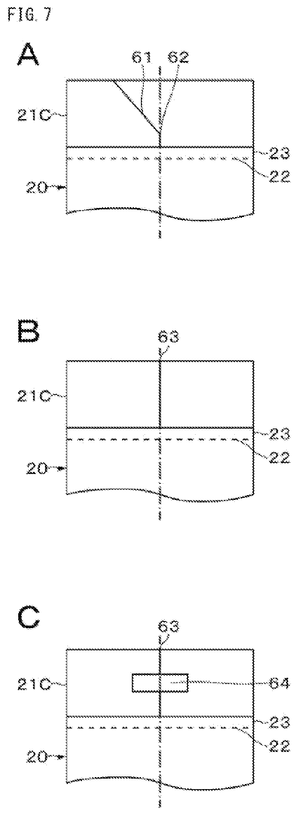

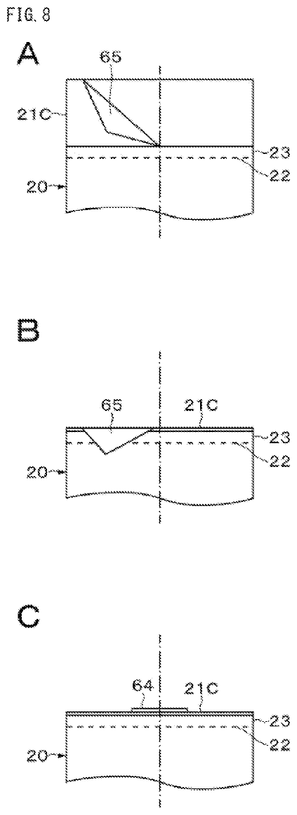

First, comparisons were made between a case with the cutout 61 at one end in the transverse direction of the positive electrode 21 on the winding end side of the electrode wound body 20 and a case without the cutout 61. After winding, the cutout 61 or the winding end part 63 of the positive electrode is located in an outermost wind of the electrode wound body. FIGS. 7A to 7C are schematic diagrams for describing Example 1 and Comparative examples 1 and 2. Each of FIGS. 7A to 7C is a side view of the electrode wound body 20 illustrating the active material uncovered part 21C of the positive electrode and the vicinity thereof. The electrode wound body 20 in each of FIGS. 7A to 7C is in a state before the active material uncovered part 21C of the positive electrode is bent toward the through hole 26 (see FIG. 4A).

### Example 1

As illustrated in FIGS. 6 and 7A, the cutout 61 was formed at one end in the transverse direction of the positive electrode 21 on the winding end side of the electrode wound body 20, and the length L of the cutout 61 along the longitudinal direction of the positive electrode 21 was set to ⅛ winds. The positive electrode 21 was wound together with the negative electrode 22 with the separator 23 interposed therebetween, and the active material uncovered part 21C of the positive electrode was bent to form the end face 41. Hc1 was set to 7 mm, and Hc2 was set to 5 mm.

### Comparative Example 1

As illustrated in FIG. 7B, no cutout 61 was formed. The positive electrode 21 was wound together with the negative electrode 22 with the separator 23 interposed therebetween, and the active material uncovered part 21C of the positive electrode was bent to form the end face 41.

### Comparative Example 2

As illustrated in FIG. 7C, no cutout 61 was formed. The positive electrode 21 was wound together with the negative electrode 22 with the separator 23 interposed therebetween, and a tape 64 was attached to the active material uncovered part 21C of the positive electrode in the winding end part 63 of the positive electrode. A base layer of the tape 64 included polyimide. The tape 64 had a thickness of 18 μm, including an adhesive layer. Dimensions of the tape 64 were 2 mm in an axial direction of the electrode wound body 20, and 10 mm in a circumferential direction. Thereafter, the active material uncovered part 21C of the positive electrode was bent to form the end face 41. At this time, the entire tape 64 was allowed to be located on the end face 41.

Batteries having the characteristics described in Example and Comparative examples above were subjected to an open circuit voltage defect test and a welding defect test. In the open circuit voltage defect test, the batteries 1 were subjected to constant current and constant voltage charging at 500 mA at an ambient temperature of 25° C. Where a voltage of the battery 1 immediately (within 1 hour) after reaching 4.2 V is denoted as V1 and a voltage of the battery 1 having been left to stand for two weeks from the point in time immediately after the voltage reached 4.2 V is denoted as V2, the battery 1 in which V1−V2≥50 mV was evaluated as having an open circuit voltage defect, and the number of such batteries 1 was counted. In the welding defect test, the positive electrode current collector plate 24 and the electrode wound body 20 were pulled away from each other with a force of 10N after laser-welding the positive electrode current collector plate 24 and the active material uncovered part 21C of the positive electrode to each other. The battery in which separation of the positive electrode current collector plate 24 was observed was evaluated as having a welding defect, and the number of such batteries was counted. The number of batteries subjected to each test was 100 for each example. The results are given in Table 1 below.

TABLE 1

| | Number of open | Number of welding |
|---|---|---|
| | circuit voltage defects | defects |
| Example 1 | 0 | 0 |
| Comparative example 1 | 6 | 0 |
| Comparative example 2 | 0 | 23 |

In Example 1, the number of the open circuit voltage defects and the number of the welding defects were both zero, whereas in Comparative example 1, the number of the open circuit voltage defects was six and the number of the welding defects was zero, and in Comparative example 2, the number of the open circuit voltage defects was zero and the number of the welding defects was 23. Regarding Comparative example 1, a reason for the defects is considered to be as follows. In the course of a manufacturing process or conveyance, as illustrated in FIG. 8A, an outwardly turned-up portion 65 can sometimes develop in the winding end part 63 on the winding end side of the positive electrode 21. If the active material uncovered part of the positive electrode is bent in such a state to form the end face 41, the turned-up portion 65 can sometimes be bent outwardly as illustrated in FIG. 8B. At this time, the turned-up portion 65 can break through the separator 23 located in the outermost wind of the electrode wound body 20, and can thus come into contact with the negative electrode 22 located on an inner side relative to the separator 23 (the broken line in FIG. 8B indicates an upper end of the negative electrode 22). It is considered that in Comparative example 1, the occurrence of such contact resulted in a short circuit. Forming the cutout 61 at one end in the transverse direction of the positive electrode 21 on the winding end side of the electrode wound body 20, as in Example 1, prevents the generation of the outwardly turned-up portion 65 on the winding end side of the positive electrode 21. This is considered to be a reason why no short circuit occurred in Example 1. In Comparative example 2, the tape 64 was attached to the winding end part 63 of the positive electrode 21. It is thus considered that the tape 64 prevented a portion of the positive electrode 21 on the winding end side from being turned up outwardly, and thereby prevented the occurrence of a short circuit. However, it is considered that the presence of the tape 64 on the end face 41 as illustrated in FIG. 8C resulted in the welding defect. From the experiment results presented in Table 1, it is determinable that neither an internal short circuit nor a welding defect will occur in a battery provided with the cutout 61 at one end in the transverse direction of the positive electrode 21 on the winding end side of the electrode wound body.

Next, comparisons were made between cases with varying lengths L of the cutout 61 along the longitudinal direction of the positive electrode 21. In Examples 2 to 5, Hc1 was set to 7 mm, and Hc2 was set to 5 mm. FIGS. 9A-1 to 9D-1 and FIGS. 9A-2 to 9D-2 are diagrams illustrating Examples 2 to 5. Each of FIGS. 9A-1 to 9D-1 is a side view of the electrode wound body 20 illustrating the active material uncovered part 21C of the positive electrode and the vicinity thereof. Each of FIGS. 9A-2 to 9D-2 is a plan view of the end face 41 on the positive electrode side after formation of the grooves 43. A thick solid-line portion in each of the plan views represents the cutout 61. The electrode wound body 20 in each of FIGS. 9A-1 to 9D-1 and FIGS. 9A-2 to 9D-2 is in a state before the active material uncovered part 21C of the positive electrode is bent toward the through hole 26 (see FIG. 4A or 4B).

### Example 2

As illustrated in FIGS. 9A-1 and 9A-2, Example 2 was similar to Example 1 except that L was set to 1/16 winds.

### Example 3

As illustrated in FIGS. 9B-1 and 9B-2, Example 3 was similar to Example 1 except that L was set to ¼ winds.

### Example 4

As illustrated in FIGS. 9C-1 and 9C-2, Example 4 was similar to Example 1 except that L was set to 1/32 winds.

### Example 5

As illustrated in FIGS. 9D-1 and 9D-2, Example 5 was similar to Example 1 except that L was set to 5/16 winds.

In a manner similar to the foregoing, batteries having the characteristics described in Example above were subjected to the open circuit voltage defect test, the welding defect test, and impedance (direct resistance) measurements. The direct resistance is obtainable by calculating a gradient of voltage when a discharge current is increased from 0 (A) to 100 (A) in five seconds. For the impedance measurements, a value of Example 1 was assumed as 100.00%. The results are given in Table 2 below.

TABLE 2

| | | Number of | Number of | |
|---|---|---|---|---|
| | | open circuit | welding | Impedance |
| | L | voltage defects | defects | (%) |
| Example 2 | 1/16 winds | 0 | 0 | 99.97 |
| Example 3 | ¼ winds | 0 | 0 | 100.06 |
| Example 4 | 1/32 winds | 2 | 0 | 99.94 |
| Example 5 | 5/16 winds | 0 | 0 | 100.10 |

In Examples 2 to 5, the number of the batteries with the open circuit voltage defects due to internal short circuits attributable to generation of a turned-up portion in the positive electrode was zero or two. It was thus confirmed that these examples were able to suppress the occurrence of the voltage defect, as compared with Comparative example 1. It was confirmed that the provision of the cutout in the active material uncovered part of the positive electrode at one end on the outer periphery side of the electrode wound body helps to prevent an internal short circuit from occurring due to generation of a turned-up portion in the positive electrode. It was confirmed that Example 5 resulted in an increase in impedance by 0.10%. This is presumably because the increased length L of the cutout 61 resulted in a decrease in area of joining between the positive electrode current collector plate 24 and the active material uncovered part 21C. These experiment results indicate that in a case where the length L of the cutout 61 falls within a range from 1/16 winds to ¼ winds both inclusive, it is possible to fabricate a battery that suppresses the occurrence of an internal short circuit, that is free from a welding defect, and that is relatively low in impedance.

Although one or more embodiments of the present technology have been described above, the contents of the present technology are not limited thereto, and various suitable modifications may be made.

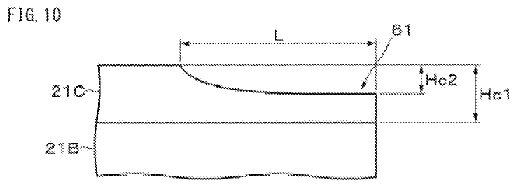

The cutout formed at the end in the transverse direction on the winding end side of the positive electrode does not have to be linear in shape such as one illustrated in FIG. 6. For example, the cutout may have a curved shape as illustrated in FIG. 10, and may have any shape that forms no turned-up portion 65 in the winding end part 63.

In an embodiment, as illustrated in FIG. 5, one laser welding mark is provided between two adjacent grooves 43; however, multiple laser welding marks may be provided between two adjacent grooves 43. In such a case, the internal resistance of the battery is further reduced owing to a further increase in area of the laser welding marks.

Although the number of the grooves 43 is eight in Examples and Comparative examples, any other number may be employed. Although the battery size employed is 21700 (21 mm in diameter and 70 mm in height), the battery size may be 18650 (18 mm in diameter and 65 mm in height) or any other size.

Although the positive electrode current collector plate 24 and the negative electrode current collector plate 25 respectively include the plate-like parts 31 and 33 each shaped like a fan, any other shape may be employed.

In an embodiment, the positive electrode 21 and the negative electrode 22 have respective structures in which the active material uncovered parts 21C and 22C are bent to be respectively welded to the current collector plates 24 and 25; however, the negative electrode 22 may have any other structure.

The present technology is applicable to any battery other than the lithium ion battery, and to any battery having a shape other than the cylindrical shape, such as a laminated battery, a prismatic battery, a coin-type battery, or a button-type battery, without departing from the scope of the present technology. In such a case, the shape of the “end face of the electrode wound body” is not limited to the cylindrical shape, and may be an elliptical shape, an elongated shape, or any other shape.

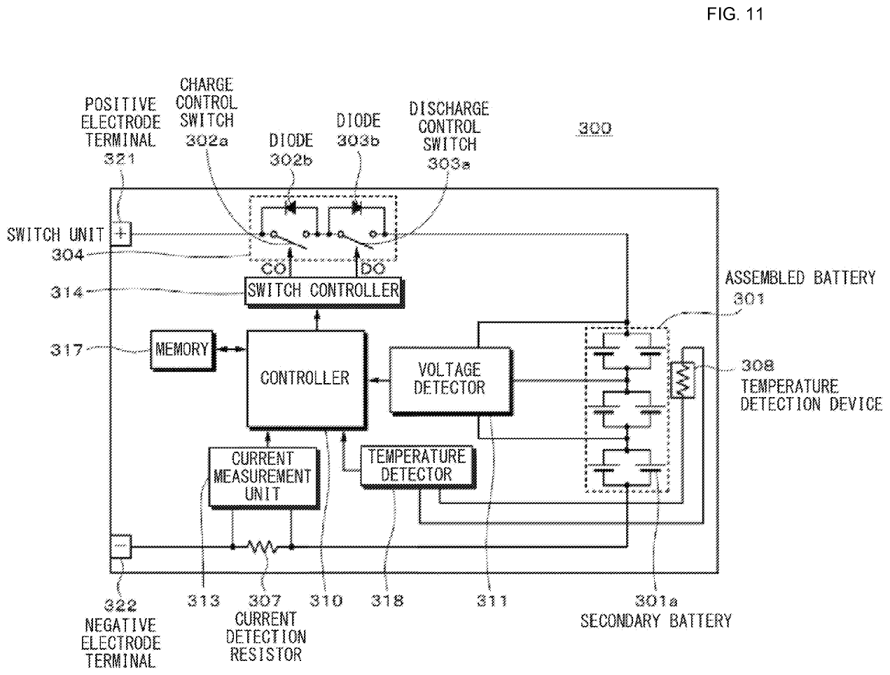

FIG. 11 is a block diagram illustrating a circuit configuration example where the battery 1 according to an embodiment including Examples of the present technology is applied to a battery pack 300. The battery pack 300 includes an assembled battery 301, a switch unit 304, a current detection resistor 307, a temperature detection device 308, and a controller 310. The switch unit 304 includes a charge control switch 302a and a discharge control switch 303a. The controller 310 controls each device. Further, the controller 310 is able to perform charge and discharge control upon abnormal heat generation, and to perform calculation and correction of a remaining capacity of the battery pack 300. The battery pack 300 includes a positive electrode terminal 321 and a negative electrode terminal 322 that are couplable to a charger or electronic equipment for charging and discharging.

The assembled battery 301 includes multiple secondary batteries 301a coupled in series or in parallel. FIG. 11 illustrates an example case in which six secondary batteries 301a are coupled in a two parallel coupling and three series coupling (2P3S) configuration.

A temperature detector 318 is coupled to the temperature detection device 308 (for example, a thermistor). The temperature detector 318 measures the temperature of the assembled battery 301 or the battery pack 300, and supplies the measured temperature to the controller 310. A voltage detector 311 measures the voltages of the assembled battery 301 and each of the secondary batteries 301a included therein, performs A/D conversion on the measured voltages, and supplies the converted voltages to the controller 310. A current measurement unit 313 measures currents using the current detection resistor 307 and supplies the measured currents to the controller 310.

A switch controller 314 controls the charge control switch 302a and the discharge control switch 303a of the switch unit 304 on the basis of the voltage and the currents respectively supplied from the voltage detector 311 and the current measurement unit 313. When the voltage of any of the secondary batteries 301a becomes greater than or equal to an overcharge detection voltage or becomes lower than or equal to an overdischarge detection voltage, the switch controller 314 transmits a turn-off control signal to the switch unit 304 to thereby prevent overcharging or overdischarging. The overcharge detection voltage is, for example, 4.20 V±0.05 V. The overdischarge detection voltage is, for example, 2.4 V±0.1 V.

After the charge control switch 302a or the discharge control switch 303a is turned off, charging or discharging is enabled only through a diode 302b or a diode 303b. Semiconductor switches such as MOSFETs are employable as these charge and discharge control switches. Note that although the switch unit 304 is provided on a positive side in FIG. 11, the switch unit 304 may be provided on a negative side.

A memory 317 includes a RAM and a ROM. Numerical values including, for example, battery characteristic values, a full charge capacity, and a remaining capacity calculated by the controller 310 are stored and rewritten therein.

The battery 1 according to an embodiment including Examples of the present technology described herein is mountable on equipment such as electronic equipment, electric transport equipment, or a power storage apparatus, and is usable to supply electric power.

Examples of the electronic equipment include laptop personal computers, smartphones, tablet terminals, personal digital assistants (PDAs) (mobile information terminals), mobile phones, wearable terminals, digital still cameras, electronic books, music players, game machines, hearing aids, electric tools, televisions, lighting equipment, toys, medical equipment, and robots. In addition, electric transport equipment, power storage apparatuses, and electric unmanned aerial vehicles, which will be described later, may also be included in the electronic equipment in a broad sense.

Examples of the electric transport equipment include electric automobiles (including hybrid electric automobiles), electric motorcycles, electric-assisted bicycles, electric buses, electric carts, automated guided vehicles (AGVs), and railway vehicles. Examples of the electric transport equipment further include electric passenger aircrafts and electric unmanned aerial vehicles for transportation. The secondary battery according to an embodiment is used not only as a driving power source for the foregoing electric transport equipment but also as, for example, an auxiliary power source or an energy-regenerative power source therefor.

Examples of the power storage apparatuses include a power storage module for commercial or household use, and a power source for power storage for architectural structures including residential houses, buildings, and offices, or for power generation facilities.

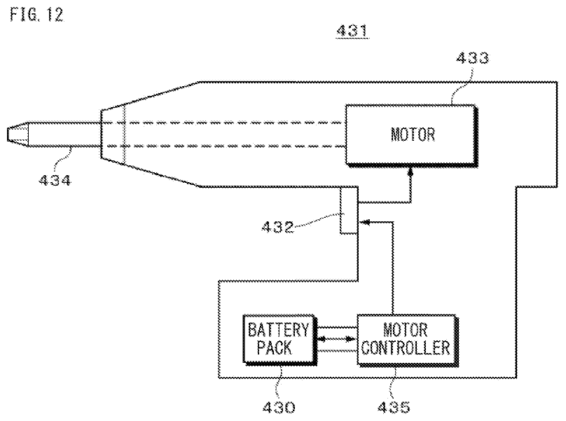

As an example of the electric tools to which the present technology is applicable, an electric screwdriver will be schematically described with reference to FIG. 12. An electric screwdriver 431 includes a motor 433 and a trigger switch 432. The motor 433 transmits rotational power to a shaft 434. The trigger switch 432 is operated by a user. A battery pack 430 according to the present technology and a motor controller 435 are contained in a lower housing of a handle of the electric screwdriver 431. The battery pack 430 is built in or detachably attached to the electric screwdriver 431. The battery 1 is applicable to a battery included in the battery pack 430.

The battery pack 430 and the motor controller 435 may include respective microcomputers (not illustrated) communicable with each other to transmit and receive charge and discharge data on the battery pack 430. The motor controller 435 controls operation of the motor 433, and is able to cut off power supply to the motor 433 under abnormal conditions such as overdischarging.

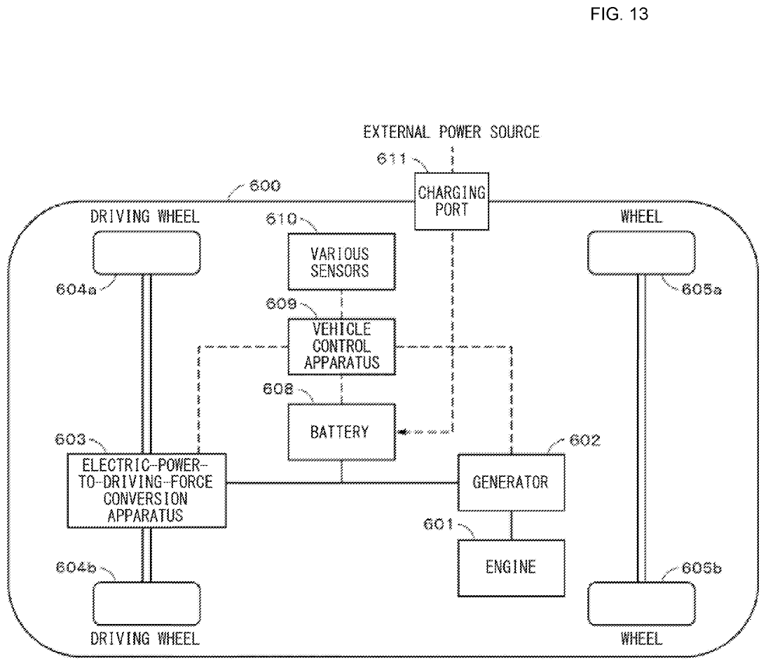

As an example of application of the present technology to a power storage system for electric vehicles, FIG. 13 schematically illustrates a configuration example of a hybrid vehicle (HV) that employs a series hybrid system. The series hybrid system relates to a vehicle that travels with an electric-power-to-driving-force conversion apparatus by using electric power generated by a generator that uses an engine as a power source, or using electric power temporarily stored in a battery.

A hybrid vehicle 600 is equipped with an engine 601, a generator 602, an electric-power-to-driving-force conversion apparatus 603 (a direct-current motor or an alternating-current motor; hereinafter, simply “motor 603”), a driving wheel 604a, a driving wheel 604b, a wheel 605a, a wheel 605b, a battery 608, a vehicle control apparatus 609, various sensors 610, and a charging port 611. The battery pack 300, or a power storage module equipped with a plurality of batteries 1 is applicable to the battery 608.

The motor 603 operates under the electric power of the battery 608, and a rotational force of the motor 603 is transmitted to the driving wheels 604a and 604b. Electric power generated by the generator 602 using a rotational force generated by the engine 601 is storable in the battery 608. The various sensors 610 control an engine speed via the vehicle control apparatus 609, and control an opening angle of an unillustrated throttle valve.

When the hybrid vehicle 600 is decelerated by an unillustrated brake mechanism, a resistance force at the time of deceleration is applied to the motor 603 as a rotational force, and regenerative electric power generated from the rotational force is stored in the battery 608. In addition, the battery 608 is chargeable by being coupled to an external power source via the charging port 611 of the hybrid vehicle 600. Such an HV vehicle is referred to as a plug-in hybrid vehicle (PHV or PHEV).

Note that the secondary battery according to the present technology may be applied to a small-sized primary battery and used as a power source of an air pressure sensor system (a tire pressure monitoring system; TMPS) built in the wheels 604 and 605.

Although the series hybrid vehicle has been described above as an example, the present technology is applicable also to a hybrid vehicle of a parallel system in which an engine and a motor are used in combination, or of a combination of the series system and the parallel system. Furthermore, the present technology is applicable to an electric vehicle (EV or BEV) and a fuel cell vehicle (FCV) that travel by means of only a driving motor without using an engine.

### REFERENCE SIGNS LIST

1: lithium ion battery
12: insulating plate
21: positive electrode
21A: positive electrode foil
21B: positive electrode active material covered part
21C: active material uncovered part of a positive electrode
22: negative electrode
22A: negative electrode foil
22B: negative electrode active material covered part
22C: active material uncovered part of a negative electrode
23: separator
24: positive electrode current collector plate
25: negative electrode current collector plate
26: through hole
27, 28: outer edge part
41, 42: end face
43: groove
51: laser welding mark
61: cutout

According to an embodiment, the cutout is provided on a winding end side of the electrode wound body. This makes it possible to provide a battery that suppresses the occurrence of an internal short circuit due to a turned-up portion generated in the positive electrode. It should be understood that the contents of the present technology are not to be construed as being limited by the effects exemplified herein.

It should be appreciated that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode wound body including a positive electrode having a band shape and a negative electrode having a band shape, the positive electrode and the negative electrode being in a stacked arrangement with a separator interposed therebetween and being wound;
a positive electrode current collector plate; and
an outer package can containing the electrode wound body and the positive electrode current collector plate, wherein
the positive electrode includes a positive electrode active material covered part in which a positive electrode foil is covered with a positive electrode active material layer, and a positive electrode active material uncovered part,
the electrode wound body includes a flat surface formed by the positive electrode active material uncovered part that protrudes from one end of the electrode wound body being bent toward a central axis of the electrode wound body and portions of the positive electrode active material uncovered part overlapping each other,
the flat surface is joined to the positive electrode current collector plate, and
the positive electrode active material uncovered part has a cutout at one end on an outer periphery side of the electrode wound body.

2. The secondary battery according to claim 1, wherein the positive electrode active material uncovered part is located in a region including a long side of the positive electrode.

3. The secondary battery according to claim 1, wherein Hc1≥Hc2 is satisfied, where Hc1 is a width of the positive electrode active material uncovered part located at one end in a transverse direction of the positive electrode, and Hc2 is a width of the cutout.

4. The secondary battery according to claim 1, wherein a proportion of a length of the cutout along a longitudinal direction of the positive electrode to a length of one wind on a peripheral surface of the electrode wound body is greater than or equal to 1/16 and less than or equal to ¼.

5. Electronic equipment comprising the secondary battery according to claim 1.

6. An electric tool comprising the secondary battery according to claim 1.
